(19) United States
(12) Patent Application Publication
(10) Pub. No.: US 2008/0295626 A1
(43) Pub. Date: Dec. 4, 2008

(54) Unidirectional Gear Drive

(76) Inventor: Leelananda Jayasuriya, Kurunegala (LK)

Correspondence Address: FURR LAW FIRM, 2622 DEBOLT ROAD, UTICA, OH, 43080, US

(21) Appl. No.: 11/756,726

(22) Filed: Jun. 1, 2007

(51) Int. Cl. F16H 29/04

(52) U.S. Cl. 74/117

(57) ABSTRACT

A mechanical assembly applicable to convert bidirectional motion of an input shaft into unidirectional motion of an output shaft comprising input shaft, intermediate shaft and output shaft, wherein two sets of gearing arranged one after the other, in combination with ratchet and pawl mechanisms driven in opposite directions, with two opposing ratchet wheels fitted to input shaft, each accompanied by a gearwheel driven on bearings on the same shaft with protruded flanges integral to aforesaid gear wheel, carrying spring loaded pawls on flanges to engage with accompanied ratchet wheel. The output shaft is coupled to input shaft by aforesaid gearings, so that the rotary movement performed either on clock wise or counterclockwise direction on input shaft will result unidirectional motion on output shaft.

### BACKGROUND

The present invention relates to gear arrangements converting bidirectional motion of a shaft in to unidirectional motion of another shaft applicable in power generation and power transmission.

The renewable energy sources such as water and wind are continuously restored by nature, and are associated mainly with periodic rising & falling of energy level. Although there are devices capable of harnessing these energy resources, they are capable of seizing energy in one direction only. Therefore there is still a need of a mechanism to seize energy in both directions.

### SUMMARY

The current invention is a mechanical assembly applicable to convert bidirectional motion of an input shaft into unidirectional motion of an output shaft comprising input shaft, intermediate shaft and output shaft, wherein two sets of gearing arranged one after the other, in combination with ratchet and pawl mechanisms driven in opposite directions, with two opposing ratchet wheels fitted to input shaft, each accompanied by a gearwheel driven on bearings on the same shaft with protruded flanges integral to aforesaid gear wheel, carrying spring loaded pawls on flanges to engage with accompanied ratchet wheel.

The output shaft is coupled to input shaft by aforesaid gearings, in which 1^{st} gear fitted on input shaft meshes directly with 1^{st} gearwheel fitted on output shaft to turn in clockwise direction only, while 2nd gear fitted to input shaft couple on the output shaft by means of intermediate gear arrangement to reserve its direction, so that when input shaft is driven either way output shaft turns in one direction only.

### BRIEF DESCRIPTION OF DRAWINGS

These features and advantages of the present invention as well as others will be fully understood when the following description is read in light of the accompanying drawings, in which:

FIG. 1 is the typical sectional view of unidirectional gear assembly

FIG. 2 is the Details of Clockwise assembly at input shaft

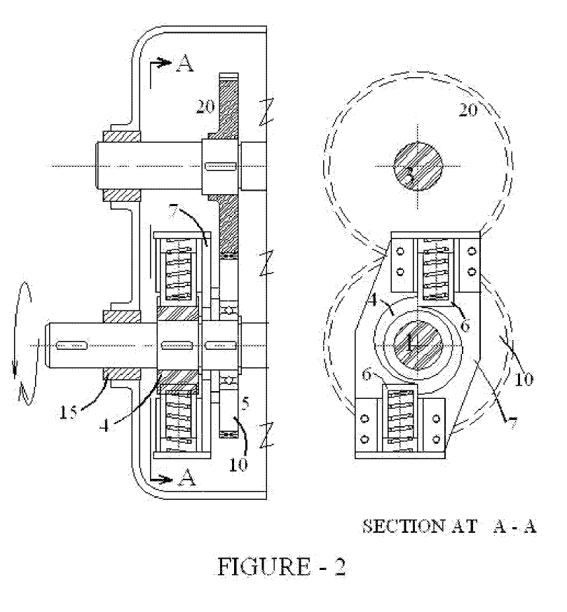

FIG. 3 is the Details of Counterclockwise assembly at input shaft

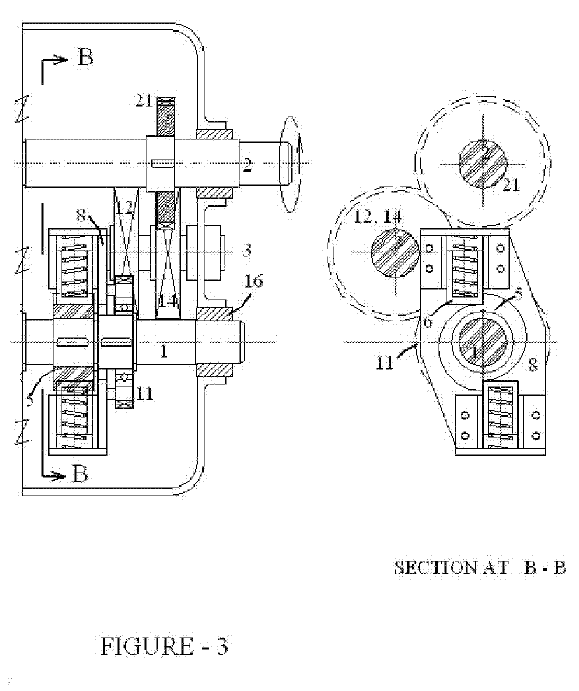

### DETAILS OF PARTS SHOWN IN ACCOMPANIED DRAWINGS

1—Input shaft for bidirectional input.
2—Intermediate shaft, for reversing gearing.
3—Output shaft, for power to take off.
4—Ratchet wheel, to drive pawls clockwise.
5—Ratchet wheel, to drive pawls counter-clockwise.
6—Spring loaded pawls.
7—Flange, connected to Gear 10, engaging ratchet 4.
8—Flange, connected to Gear 11, engaging ratchet 5.
10—Gear wheel fitted on Shaft 1, driven on bearings driving clockwise.
11—Gear wheel fitted on Shaft 1, driven on bearings driving counterclockwise.
12—Gear wheel on intermediate shaft meshing with gear 11.
14—Gear wheel on intermediate shaft meshing with gear 21.
15, 16—Bearings to supported shaft 1.
20—Gear on output shaft, meshing with Gear 10.
21—Gear on output shaft meshing reversing the rotation on gear 11.

### DESCRIPTION

The present invention relates to gear arrangements converting bidirectional motion of a shaft into unidirectional motion of another shaft applicable in power generation and power transmission.

The renewable energy sources such as water and wind are continuously restored by nature, and are associated mainly with periodic rising & falling of energy level. Although there are devices capable of harnessing these energy resources, they are capable of seizing energy in one direction only. Therefore there is still a need of a mechanism to seize energy in both directions.

When the wobbling movement of a floating body is connected to a rack of gears, this rack of gears will move up and down. Resulting reciprocal movement could be taken up by a pinion to generate oscillatory movement on a shaft. Such oscillatory movement is turned to unidirectional motion using this invention. Harnessing the immense wave power in the world's oceans can be part of the solution to word's energy needs.

On the other hand there are numerous applications in industry requiring bidirectional motion to be converted to unidirectional motion.

An object of this invention is to provide apparatus and method capable of converting bidirectional motion power available in a source to harness as unidirectional motion which will be available as useful power to consumer.

According to the invention there is provided a mechanical assembly comprising two sets of gearing arranged one after the other in combination with ratchet and pawl mechanisms driven in opposite directions accompanied by three shafts namely input shaft, intermediate shaft and output shaft. The input shaft is fitted with two opposing ratchet wheels axially while each ratchet wheel accompanied by a gearwheels driven on bearings on the same shaft. Protruded flanges, connected to aforesaid gear wheel, are carrying spring loaded pawls sliding in guides along radial direction to the axis of the input shaft. Therefore in operation, bidirectional movements cause the pawl key to engage the slots in ratchet wheel until it disengage and ride on the periphery of the ratchet surface and drops to the next slot. As long as the pawl catches in the teeth, the ratchet wheel carries flange and gear wheel connected with pawl, turning about its axis. When the input shaft turns the other way, the pawl disengages the slot in ratchet wheel and slides over the ratchet surface to drop in the next recess.

The output shaft is coupled to input shaft, by the aforesaid two consecutively arranged gearings, in which 1^{st} gear fitted on input shaft meshes directly with, 1^{st} gearwheel fitted on output shaft which turns in clockwise direction only, while 2nd gear fitted to input shaft couple the output shaft, by means of counter gear arrangement to reserve its direction by means of intermediate shaft. So that in operation rotary movement performed either on clockwise or counterclockwise direction on input shaft will result in unidirectional motion on output shaft.

This type of gear is applicable in harnessing wave power with a floating bob. When the wobbling movement of such floating body is connected to a rack of gears, it can move up and down, so that the reciprocal movement is taken up by a rack of gears and transferred as oscillatory motion to a pinion fitted on to the input shaft. This oscillatory motion is converted to unidirectional rotary motion using this apparatus. The resulting unidirectional motion is useful power that can be directly consumed as mechanical power or convertible to electricity using an electrical power generator. Plurality of such devices may be connected to a single power takeoff shaft to obtain higher power. Similarly this type of device is applicable in power transmission as well.

### EXAMPLES OF DESIGN

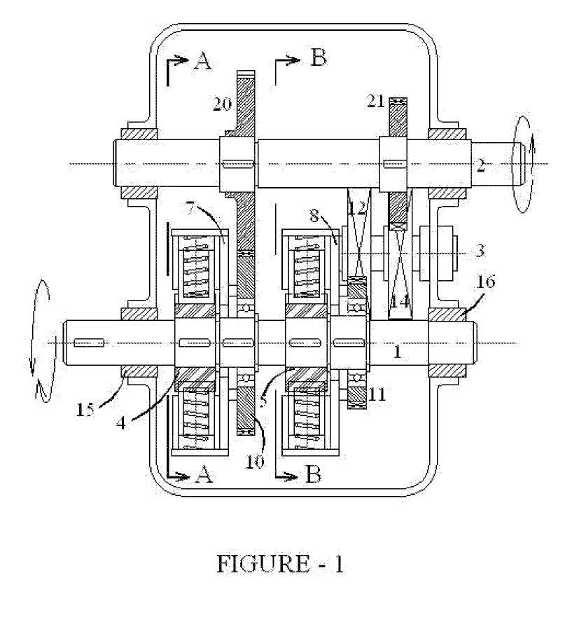

Referring to FIG. 1, ratchet wheels 4 & 5 are keyed to input shaft 1 which is oscillating in operation, to engage pawls in clockwise direction and counter clockwise direction respectively. Each ratchet wheel is accompanied by a gear wheel 10 and 11 running on bearing on the same input shaft. The two gear wheels are fitted with protruded flanged 7 and 8, carrying spring loaded prismatic pawls that engage slots on ratchet wheels. So that the pawls are driven by ratchet wheels along with the accompanied flange and gearwheel running on bearings on the same input shaft.

The gear wheels 12 and 14 are secured to intermediate shaft to mesh continuously with the gear wheel 11 on input shaft and gear 12 on output shaft, thereby reversing the motion imparted on gear wheel 11. This way the oscillatory motion on input shaft in either direction are independently taken up and are brought onto a single output shaft 3 resulting in unidirectional rotary motion on output shaft. The pawls are set forth to move along the radial direction of the axis of shaft 1. Advantageously such gearing prevents unintentional rotation of pawl housing over the oscillating shaft, as well.

Plurality of such devices may be connected to a single power takeoff shaft to obtain higher power.

This type of gear is applicable in harnessing wave power with a floating bob. When the wobbling movement of such floating body is connected to a rack of gears, it can move up and down so that the reciprocal movement is taken up by a rack of gears and transferred as oscillatory motion to a pinion fitted onto the input shaft. This oscillatory motion is converted to unidirectional rotary motion using this apparatus. The resulting unidirectional motion is useful power that can be directly applicable as mechanical power or convertible to electricity using an electrical power generator.

Plurality of such devices may be connected to a single power takeoff shaft to obtain higher power.

Similarly this type of device is applicable in power transmission as well.

With respect to the above description, it is to be realized that the optimum dimensional relationships for the parts of the invention are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A mechanical assembly applicable to convert bidirectional motion of a shaft in to unidirectional motion of an output shaft comprising
means forming for two sets of gearing arranged one after the other,
means for three shafts namely input shaft, intermediate shaft and output shaft, supported on bearings,
means for aforesaid input shaft to be fitted with two opposing ratchet wheels axially one after the other at definite intervals
means to introduce two gear wheels running on bearings on input shaft to accompany each ratchet wheel
means for protruded flanges extending from afore said gearwheels to seize spring loaded pawls engaging the accompanied ratchet wheel
means to engage spring loaded prismatic pawls on aforesaid ratchet wheels
means to drive aforesaid gear wheel with the accompanied pawls when it engage with the slots in ratchet wheel and drive on the driven direction
means for gearing to couple the first gearing on input shaft directly with the first gear on out put shaft while the second gear on input shaft with the second gear on out put shaft by an intermediate shaft to reverse its direction
so that in operation bidirectional motion imparted on input shaft results unidirectional motion on output shaft.

2. A mechanical assembly applicable to convert bidirectional motion of an input shaft in to unidirectional motion of an output shaft as claimed in claim 1 characterized by pawls engaging the slots on ratchet wheels in radial direction.

3. A mechanical assembly applicable to convert bidirectional motion of an input shaft in to unidirectional motion of an output shaft as claimed in claim 1 characterized by the prismatic pawls engaging the slots on ratchet wheels in radial direction.

4. A mechanical assembly applicable to convert bidirectional motion of an input shaft in to unidirectional motion of an output shaft as claimed in claim 1 where a gear mechanism applicable in harnessing wave power with a floating bob, causing reciprocal movement and thereby oscillatory motion on a rack and pinion connected to the input shaft of an apparatus.

5. A mechanical assembly applicable to convert bidirectional motion of an input shaft in to unidirectional motion of an output shaft as claimed in claim 2 where a gear mechanism applicable in harnessing wave power with a floating bob, causing reciprocal movement and thereby oscillatory motion on a rack and pinion connected to the input shaft of an apparatus.

6. A mechanical assembly applicable to convert bidirectional motion of an input shaft in to unidirectional motion of an output shaft as claimed in claim 3 where a gear mechanism applicable in harnessing wave power with a floating bob, causing reciprocal movement and thereby oscillatory motion on a rack and pinion connected to the input shaft of an apparatus.

7. A mechanical assembly applicable to convert bidirectional motion of an input shaft in to unidirectional motion of an output shaft as claimed in claim 1 where a Plurality of gear mechanisms connected to a single power takeoff shaft to obtain higher power.

8. A mechanical assembly applicable to convert bidirectional motion of an input shaft in to unidirectional motion of an output shaft as claimed in claim 2 where a Plurality of gear mechanisms connected to a single power takeoff shaft to obtain higher power as claimed.

9. A mechanical assembly applicable to convert bidirectional motion of an input shaft in to unidirectional motion of an output shaft as claimed in claim 3 where a Plurality of gear mechanisms connected to a single power takeoff shaft to obtain higher power

10. A mechanical assembly applicable to convert bidirectional motion of an input shaft in to unidirectional motion of an output shaft as claimed in claim 4 where a Plurality of gear mechanisms connected to a single power takeoff shaft to obtain higher power.

11. A mechanical assembly applicable to convert bidirectional motion of an input shaft in to unidirectional motion of an output shaft as claimed in claim 1 where a Plurality of gear mechanisms connected to a single power takeoff shaft to obtain higher power as claimed.

12. A mechanical assembly applicable to convert bidirectional motion of an input shaft in to unidirectional motion of an output shaft as claimed in claim 2 where a Plurality of gear mechanisms connected to a single power takeoff shaft to obtain higher power.

13. A mechanical assembly applicable to convert bidirectional motion of an input shaft in to unidirectional motion of an output shaft as claimed in claim 3 where a Plurality of gear mechanisms connected to a single power takeoff shaft to obtain higher power.

14. A mechanical assembly applicable to convert bidirectional motion of an input shaft in to unidirectional motion of an output shaft as claimed in claim 4 where a Plurality of gear mechanisms connected to a single power takeoff shaft to obtain higher power.

15. A mechanical assembly applicable to convert bidirectional motion of an input shaft in to unidirectional motion of an output shaft as claimed in claim 1 where a Plurality of gear mechanisms connected to a single power takeoff shaft to obtain higher power.

16. A mechanical assembly applicable to convert bidirectional motion of an input shaft in to unidirectional motion of an output shaft as claimed in claim 2 where a Plurality of gear mechanisms connected to a single power takeoff shaft to obtain higher power.

17. A mechanical assembly applicable to convert bidirectional motion of an input shaft in to unidirectional motion of an output shaft as claimed in claim 3 where a Plurality of gear mechanisms connected to a single power takeoff shaft to obtain higher power.

18. A mechanical assembly applicable to convert bidirectional motion of an input shaft in to unidirectional motion of an output shaft as claimed in claim 4 where a Plurality of gear mechanisms connected to a single power takeoff shaft to obtain higher power.

19. A mechanical assembly applicable to convert bidirectional motion of an input shaft in to unidirectional motion of an output shaft as claimed in claim 1 where a Plurality of gear mechanisms connected to a single power takeoff shaft to obtain higher power.

20. A mechanical assembly applicable to convert bidirectional motion of an input shaft in to unidirectional motion of an output shaft as claimed in claim 2 where a Plurality of gear mechanisms connected to a single power takeoff shaft to obtain higher power.
